(19) United States
(12) Patent Application Publication
(10) Pub. No.: US 2026/0179926 A1
(43) Pub. Date: Jun. 25, 2026

(54) NEGATIVE ELECTRODE AND RECHARGEABLE LITHIUM BATTERY INCLUDING THE SAME

(71) Applicant: SAMSUNG SDI CO., LTD., Yongin-si (KR)

(72) Inventors: HOYONG AN, Yongin-si (KR); GURNYOUNG JO, Yongin-si (KR); Minjun KIM, Yongin-si (KR); Suji KIM, Yongin-si (KR); Keemin PARK, Yongin-si (KR); Yeseul KIM, Yongin-si (KR); Yunsung KIM, Yongin-si (KR); Juhyung LEE, Yongin-si (KR); Geunhong SIM, Yongin-si (KR)

(73) Assignee: SAMSUNG SDI CO., LTD., Yongin-si (KR)

(21) Appl. No.: 19/422,776

(22) Filed: Dec. 17, 2025

(30) Foreign Application Priority Data
Dec. 24, 2024 (KR) 10-2024-0195093

(51) Int. Cl. H01M 4/36; H01M 4/02; H01M 4/133; H01M 4/134; H01M 4/38; H01M 4/587; H01M 10/0525

(52) U.S. Cl. CPC H01M 4/366; H01M 4/133; H01M 4/134; H01M 4/364; H01M 4/386; H01M 4/587; H01M 10/0525; H01M 2004/021; H01M 2004/027

(57) ABSTRACT

The present disclosure relates to a negative electrode and a rechargeable lithium battery including the negative electrode. The negative electrode includes a negative electrode current collector, a first negative electrode active material layer on the negative electrode current collector, and a second negative electrode active material layer on the first negative electrode active material layer. The first negative electrode active material layer includes a porous carbon structure and a silicon-carbon composite. The porous carbon structure includes graphene, and the second negative electrode active material layer includes graphite.

### CROSS-REFERENCE TO RELATED APPLICATION

This U.S. nonprovisional application claims priority under 35 U.S.C § 119 to Korean Patent Application No. 10-2024-0195093 filed on Dec. 24, 2024 in the Korean Intellectual Property Office, the disclosure of which is hereby incorporated by reference in its entirety.

### BACKGROUND

With increasing presence of battery-powered electronic devices such as, e.g., mobile phones, notebook computers, electric vehicles, and the like, the demand for rechargeable batteries with high energy density and large capacity has been increasing significantly. In response, enhancing the performance of rechargeable lithium batteries may be advantageous.

A rechargeable lithium battery generally includes a positive electrode, a negative electrode, and an electrolyte. Both the positive and negative electrodes contain active materials capable of lithium-ion intercalation and deintercalation. Electrical energy is generated through oxidation and reduction reactions as lithium ions move between the electrodes during charging and discharging.

### SUMMARY

The present disclosure describes a negative electrode having a low expansion rate during charging and discharging.

The present disclosure also describes a rechargeable lithium battery having a long lifespan.

An example embodiment of the present disclosure includes a negative electrode including a negative electrode current collector, a first negative electrode active material layer on the negative electrode current collector, and a second negative electrode active material layer on the first negative electrode active material layer. The first negative electrode active material layer includes a porous carbon structure and a silicon-carbon composite. The porous carbon structure includes graphene, and the second negative electrode active material layer includes graphite.

In an example embodiment of the present disclosure, a negative electrode includes a negative electrode current collector, a first negative electrode active material layer including a first region and a second region, and a second negative electrode active material layer on the first negative electrode active material layer. The first region and the second region are disposed side by side in a horizontal direction. The first region includes a porous carbon structure. The second region includes a silicon-carbon composite, and the second negative electrode active material layer includes graphite.

In an example embodiment of the present disclosure, a rechargeable lithium battery includes the negative electrode described above.

### BRIEF DESCRIPTION OF DRAWINGS

FIG. 1 is a simplified conceptual diagram illustrating a rechargeable lithium battery according to example embodiments of the present disclosure.

FIG. 2 to FIG. 5 are cross-sectional views schematically illustrating a rechargeable lithium battery according to an example embodiment. FIG. 2 shows a cylindrical type, FIG. 3 shows a prismatic type, and FIG. 4 and FIG. 5 show pouch-type batteries.

FIG. 6 is a cross-sectional view of a negative electrode according to one example embodiment of the present disclosure.

FIG. 7 is an enlarged view of region “M” of FIG. 6.

FIG. 8 is a schematic diagram illustrating a porous carbon structure according to the present disclosure.

FIG. 9 is a cross-sectional view of a negative electrode according to another example embodiment of the present disclosure.

FIG. 10 is an enlarged view of region “N” of FIG. 9.

FIG. 11 is a cross-sectional view of a negative electrode according to another example embodiment of the present disclosure.

FIG. 12 is a cross-sectional view of a negative electrode according to another example embodiment of the present disclosure.

### DETAILED DESCRIPTION

To fully understand the configuration and effects of the present disclosure, some example embodiments are described with reference to the accompanying drawings. However, the present disclosure is not limited to the following example embodiments and may be implemented in various forms. The example embodiments are provided solely to illustrate the present disclosure and to enable those skilled in the art to fully understand the scope thereof.

In this description, when an element is described as being “on” another element, the element may be directly on the other element, or one or more intervening elements may be present therebetwen. In the drawings, certain thicknesses may be exaggerated to better illustrate technical details. Throughout the specification, like reference numerals indicate like elements.

The example embodiments described herein may be illustrated using sectional and/or plan views, which are presented as idealized examples of the present disclosure. The thicknesses of layers and regions in the drawings may be exaggerated for clarity. The regions shown in the drawings are for illustrative purposes and should not be construed as limiting the scope of the present disclosure. Although terms such as “first,” “second,” and “third” may be used to describe various elements, these terms are merely for distinction and do not imply any particular order or hierarchy. The example embodiments described and illustrated herein include complementary variations.

The terms used in this description serve only to explain various example embodiments, and are not intended to limit the present disclosure. Unless explicitly stated otherwise, singular forms may also include plural forms. The terms “comprises/includes” and “comprising/including” do not exclude the presence or addition of one or more other components.

In this description, the phrase “combination thereof” may refer to a mixture, a stack, a composite, a copolymer, an alloy, a blend, or a reaction product.

Unless otherwise specifically defined, the term “particle diameter” refers to an average particle diameter. The particle diameter may represent the median particle size (D50), which corresponds to the diameter of particles at 50 vol % in a cumulative particle size distribution. The average particle diameter (D50) can be measured using widely known methods, such as, e.g., a particle size analyzer, transmission electron microscope (TEM) imaging, or scanning electron microscope (SEM) imaging. Alternatively, dynamic light scattering may be used, where particle counts within size ranges are analyzed to calculate the average particle diameter (D50). Additionally, a laser scattering method may be employed, in which a target particle is dispersed in a solvent, introduced into a laser scattering particle measurement device (e.g., MT3000 from Microtrac, Inc.), irradiated with ultrasonic waves at 28 kHz and 60 W, and subsequently analyzed to determine the D50 value based on a 50% cumulative particle size distribution.

The phrases “A or B,” “at least one of A and B,” “at least one of A or B,” “A, B, or C,” “at least one of A, B, and C,” and “at least one of A, B, or C” include any one or all possible combinations of the listed elements.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

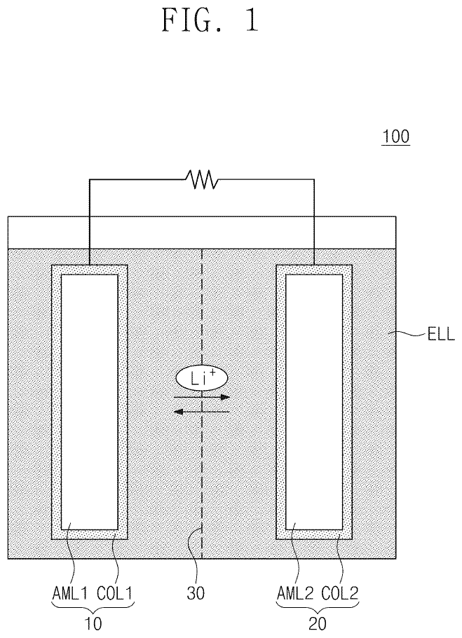

FIG. 1 is a simplified conceptual diagram illustrating a rechargeable lithium battery according to example embodiments of the present disclosure. Referring to FIG. 1, the rechargeable lithium battery may include a positive electrode 10, a negative electrode 20, a separator 30, and an electrolyte solution ELL.

The positive electrode 10 and the negative electrode 20 may be spaced apart from each other with the separator 30 therebetween. The separator 30 may be disposed between the positive electrode 10 and the negative electrode 20. The positive electrode 10, the negative electrode 20, and the separator 30 may be in contact with the electrolyte solution ELL. The positive electrode 10, the negative electrode 20, and the separator 30 may be impregnated in the electrolyte solution ELL.

The electrolyte solution ELL may be or include a medium for transferring lithium ions between the positive electrode 10 and the negative electrode 20. In the electrolyte solution ELL, the lithium ions may move through the separator 30 toward the positive electrode 10 or the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material, and may further include a binder and/or a conductive material.

For example, the positive electrode 10 may further include an additive that may constitute a sacrificial positive electrode.

An amount of the positive electrode active material in the positive electrode active material layer AML1 may be in a range of about 90 wt % to about 99 wt % based on 100 wt % of the positive electrode active material layer AML1. An amount of each of the binder and the conductive material may independently be in a range of about 0.5 wt % to about 5 wt % based on 100 wt % of the positive electrode active material layer AML1.

The binder attaches the positive electrode active material particles to each other, and attaches the positive electrode active material to the current collector COL1. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, and the like, as non-limiting examples.

The conductive material may impart conductivity to the electrode. Any material that does not cause an adverse chemical change, and that conducts electrons, may be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in a form of a metal powder or a metal fiber; a conductive polymer such as a polyphenylene derivative; or a mixture thereof.

Al may be used as the current collector COL1, but the material of the current collector COL1 is not limited thereto.

### Positive Electrode Active Material

The positive electrode active material in the positive electrode active material layer AML1 may include a compound (lithiated intercalation compound) that is capable of reversibly intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following chemical formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O₂₋ₐDₐ (0.90≤a≤1.8, 0≤b≤0.5, 0≤c≤0.5, and 0<α<2); LiₐNi_{1-b-c}Mn_{b}X_{c}O_{2-α}D_{α} (0.90≤α≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoGbO₂ (0.90≤a≤1.8 and 0.001≤b≤0.1); LiₐMn_{1-b}G_{b}O₂ (0.90≤a≤1.8 and 0.001≤b≤0.1); LiₐMn₂GbO₄ (0.90≤a≤1.8 and 0.001≤b≤0.1); LiₐMn_{1-g}G_{g}PO₄ (0.90≤a≤1.8 and 0≤g≤0.5); Li_{(3-f}Fe₂(PO₄)₃ (0≤f≤2); LiₐFePO₄ (0.90≤a≤1.8).

In the above chemical formulas, A is or includes at least one of Ni, Co, Mn, or a combination thereof, X is or includes at least one of Al, Ni, Co, Mn, Cr, Fe, Mg, Sr, V, a rare earth element or a combination thereof, D is or includes at least one of O, F, S, P, or a combination thereof; G is or includes at least one of Al, Cr, Mn, Fe, Mg, La, Ce, Sr, V, or a combination thereof, and L is or includes at least one of Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of the metal excluding lithium in the lithium transition metal composite oxide. The high-nickel-based positive electrode active material may be capable of exhibiting high capacity, and can be applied to a high-capacity, high-density rechargeable lithium battery.

### Negative Electrode 20

The negative electrode 20 for a rechargeable lithium battery includes a current collector COL2, and a negative electrode active material layer AML2 on the current collector COL2. The negative electrode active material layer AML2 may include a negative electrode active material, and may further include a binder and/or a conductive material.

For example, the negative electrode active material layer AML2 may include a range of about 90 wt % to about 99.5 wt % of the negative electrode active material, a range of about 0.5 wt % to about 5 wt % of the binder, and a range of about 0 wt % to about 5 wt % of the conductive material.

The binder may attach the negative electrode active material particles to each other, and may also attach the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity to the electrode. Any material that does not cause an adverse chemical change, and that conducts electrons, may be used in the battery. Non-limiting examples thereof may include a carbon-based material such as or including at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in the form of a metal powder or a metal fiber; a conductive polymer such as a polyphenylene derivative; or a mixture thereof.

The negative current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as crystalline carbon, amorphous carbon, or a combination thereof. The crystalline carbon may be or include graphite such as non-shaped (amorphous), sheet-shaped (plate-like), flake-shaped, sphere-shaped (spherical), or fiber-shaped (fibrous) natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x≤2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof), or a combination thereof. The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon applied onto the surface of the silicon particles. For example, the silicon-carbon composite may include a secondary particle (core) in which primary silicon particles are assembled, and an amorphous carbon coating layer (shell) on the surface of the secondary particle. The amorphous carbon may also be present between the primary silicon particles, and for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

### Separator 30

Depending on the type of the rechargeable lithium battery, the separator 30 may be present between the positive electrode 10 and the negative electrode 20. The separator 30 may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator 30 may include a porous substrate and a coating layer including an organic material, an inorganic material, or a combination thereof, on one surface or on both surfaces of the porous substrate.

The porous substrate may be or include a polymer film formed of or including any one polymer such as at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

### Electrolyte Solution ELL

The electrolyte solution ELL for a rechargeable lithium battery includes a non-aqueous organic solvent and a lithium salt.

The non-aqueous organic solvent constitutes a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond), and the like; amides such as dimethylformamide; dioxolanes such as 1,3-dioxolane, 1,4-dioxolane, and the like; sulfolanes, and the like.

The non-aqueous organic solvents may be used alone, or in combination of two or more solvents.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent supplies lithium ions in a battery, enables an operation of a rechargeable lithium battery, and improves transportation of the lithium ions between positive and negative electrodes. Examples of the lithium salt include at least one, or two or more, of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, lithium bis(fluorosulfonyl)imide (Li(FSO₂)₂N, LiFSI), LiC₄F₉SO₃, LiN(CₓF₂ₓ₊₁SO₂)(C_{y}F_{2y+1}SO₂) (where, x and y are integers in a range of 1 to 20), lithium trifluoromethane sulfonate, lithium tetrafluoroethanesulfonate, lithium difluorobis(oxalato)borate (LiDFOB), lithium difluorobis(oxalato)phosphate (LiDFBOP), and lithium bis(oxalato) borate (LiBOB).

### Rechargeable Lithium Battery

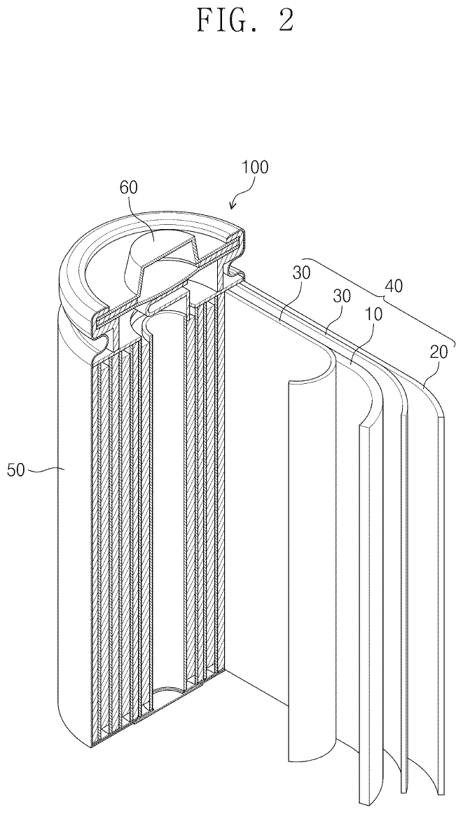

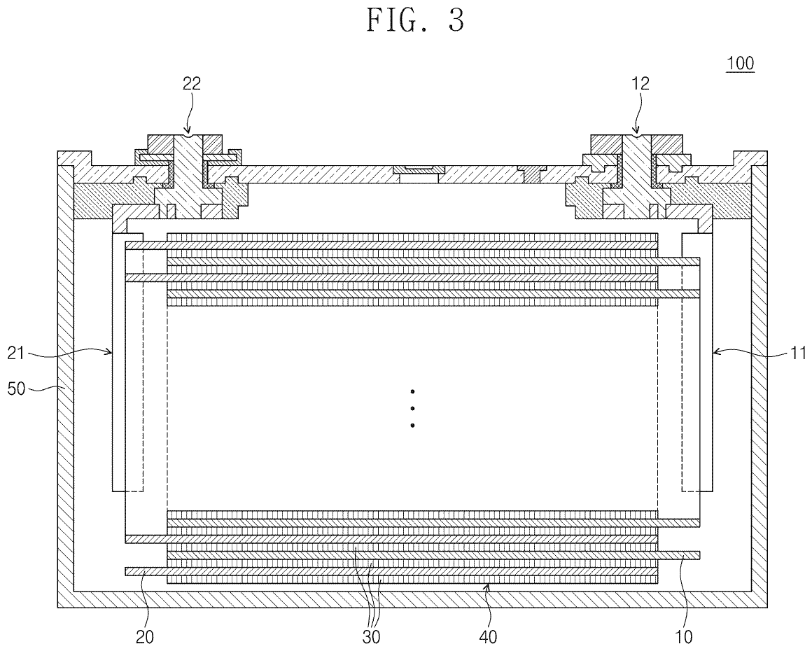

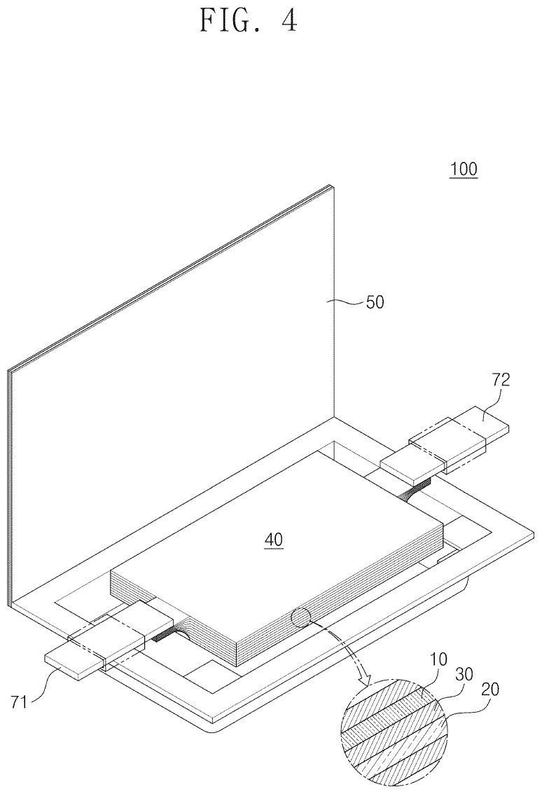

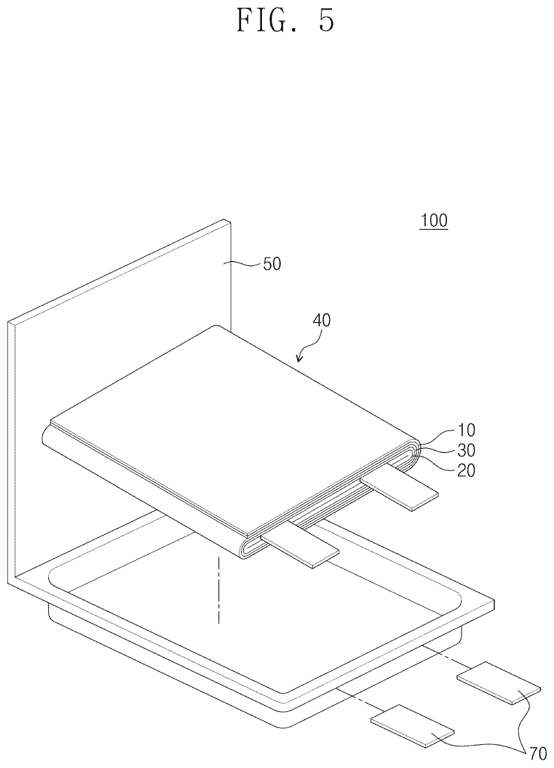

The rechargeable lithium battery may be classified into cylindrical, prismatic, pouch, coin-type batteries, and the like depending on the shape thereof. FIG. 2 to FIG. 5 are schematic views illustrating a rechargeable lithium battery according to an example embodiment. FIG. 2 shows a cylindrical battery, FIG. 3 shows a prismatic battery, and FIG. 4 and FIG. 5 show pouch-type batteries. Referring to FIG. 2 to FIG. 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may also include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 4 and FIG. 5, the rechargeable lithium battery 100 may include an electrode tab 70 illustrated in FIG. 5, or, for example, a positive electrode tab 71 and a negative electrode tab 72 illustrated in FIG. 4, the electrode tabs 70/71/72 forming an electric path for inducing the current formed in the electrode assembly 40 to the outside of the battery 100.

The rechargeable lithium battery according to an example embodiment of the present disclosure may be applied to, e.g., automobiles, mobile phones, and/or various types of electric devices, and the present disclosure is not limited thereto.

Hereinafter, the negative electrode 20 according to example embodiments of the present disclosure is described in detail. For convenience of description, descriptions of the same features as described with reference to FIG. 1 to FIG. 5 are omitted, and differences therewith are described in detail.

### Negative Electrode 20

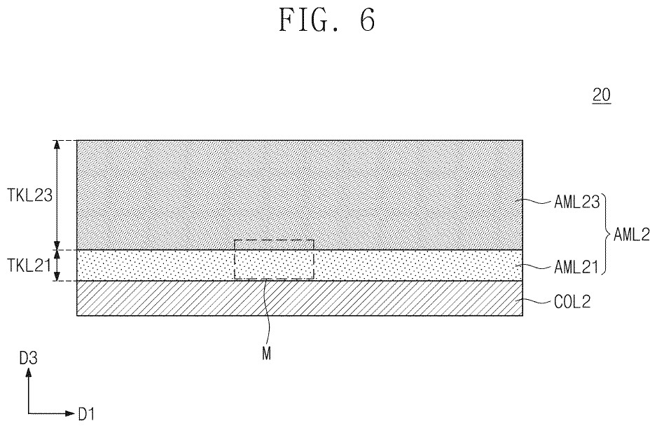

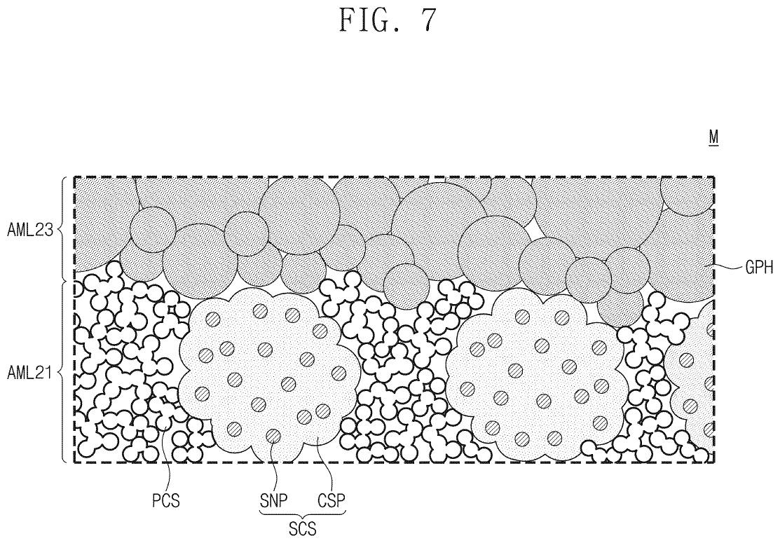

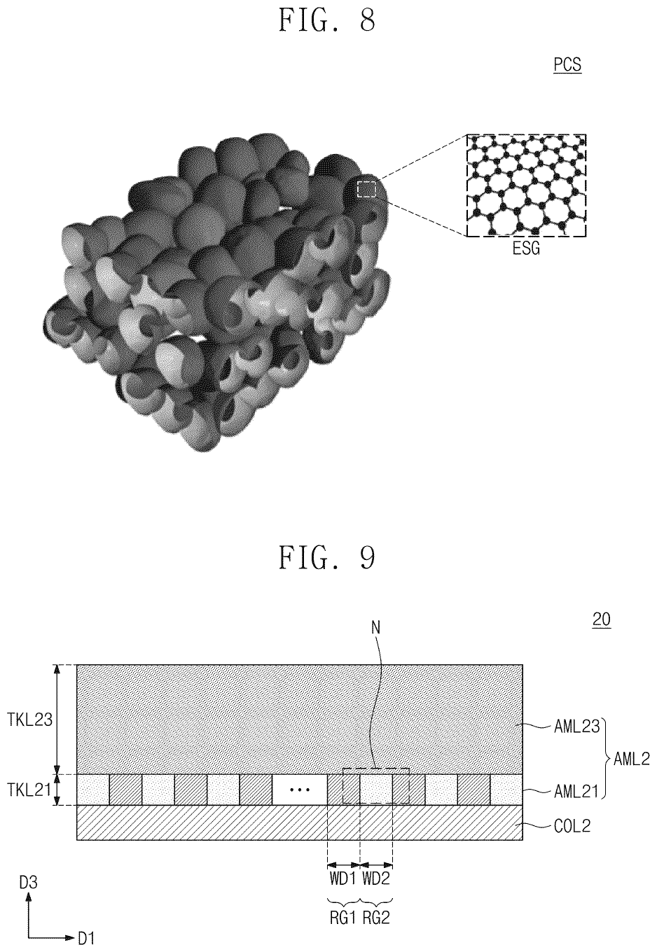

FIG. 6 is a cross-sectional view of the cathode according to an example embodiment of the present disclosure. FIG. 7 is an enlarged view of region “M” of FIG. 6. FIG. 8 is a schematic diagram for explaining the porous carbon structure.

Referring to FIG. 6, the negative electrode 20 according to an example embodiment of the present disclosure may include a current collector COL2, a first negative electrode active material layer AML21 on the current collector COL2, and a second negative electrode active material layer AML23 on the first negative electrode active material layer AML21.

A thickness TKL21 of the first negative electrode active material layer AML21 may be in a range of about 5 m to about 20 m. For example, the thickness TKL21 of the first negative electrode active material layer AML21 may be in a range of about 7 m to about 15 m.

A thickness TKL23 of the second negative electrode active material layer AML23 may be in a range of about 25 m to about 300 m. For example, the thickness TKL23 of the second negative electrode active material layer AML23 may be in a range of about 25 m or more, about 35 m or more, about 50 m or more, or about 80 m or more, and about 300 m or less, about 200 m or less, or about 150 m or less.

A ratio of the thickness TKL21 of the first negative electrode active material layer AML21 to the thickness TKL23 of the second negative electrode active material layer AML23 may be in a range of about 1:5 to about 1:15. For example, the ratio of the thickness TKL21 of the first negative electrode active material layer AML21 to the thickness TKL23 of the second negative electrode active material layer AML23 may be in a range of about 1:7 to about 1:12. When the thickness TKL21 of the first negative electrode active material layer AML21, the thickness TKL23 of the second negative electrode active material layer AML23, and the thickness ratio satisfy the above-described ranges, the second negative electrode active material layer AML23 may absorb expansion of the first negative electrode active material layer AML21 that may occur during charging and discharging, and excessive increase in volume of the negative electrode 20 may be reduced or prevented. Thereby, an expansion rate of the negative electrode 20 during charging and discharging may be reduced, and a rechargeable lithium battery with a long lifespan may be provided.

The description of the current collector COL2 is as described above.

Referring to FIG. 7, the first negative electrode active material layer AML21 may include a porous carbon structure PCS and a silicon-carbon composite SCS, and may further include a binder and/or a conductive material. The second negative electrode active material layer AML23 may include graphite GPH, and may further include a binder and/or a conductive material. The description of the binder and the conductive material are as described above.

The first negative electrode active material layer AML21 may include a range of about 80 wt % to about 99 wt % of a combination of the porous carbon structure PCS and the silicon-carbon composite SCS, a range of about 0.5 wt % to about 19 wt % of the binder, and a range of about 0 wt % to about 5 wt % of the conductive material.

A weight ratio of the porous carbon structure PCS to the silicon-carbon composite SCS in the first negative electrode active material layer AML21 may be in a range of about 1:90 to about 1:99. For example, the weight ratio of the porous carbon structure PCS to the silicon-carbon composite SCS in the first negative electrode active material layer AML21 may be in a range of about 1:94 to about 1:99, or about 1:95 to about 1:97. When the weight ratio of the porous carbon structure PCS to the silicon-carbon composite SCS in the first negative electrode active material layer AML21 satisfies the above-described range, expansion of the silicon-carbon composite SCS that may occur during charge and discharge may be absorbed. Thereby, the expansion rate of the negative electrode 20 during charging and discharging may be reduced, and a rechargeable lithium battery with a long lifespan may be provided.

The second negative electrode active material layer AML23 may include a range of about 90 wt % to about 99 wt % of the graphite GPH, a range of about 0.5 wt % to about 5 wt % of the binder, and a range of about 0 wt % to about 5 wt % of the conductive material.

Referring to FIG. 8, the porous carbon structure PCS may include graphene ESG. The graphene ESG may have an embossed structure. Within the porous carbon structure PCS, the graphene ESG may form pores. The surface of the pores may be surrounded by the graphene ESG.

The porous carbon structure PCS may include mesopores. The mesopores may have a diameter in a range of about 2 nm to about 50 nm. For example, the mesopores may have a diameter in a range of about 2 nm to about 10 nm. For example, the diameter of pores in the porous carbon structure PCS may be determined using the BJH (Barrett-Joyner-Halenda) method.

The porous carbon structure PCS may have a relatively large specific surface area. The Brunauer-Emmett-Teller (BET) specific surface area of the porous carbon structure PCS may be in a range of about 1000 m²/g to about 2200 m²/g. For example, the BET specific surface area of the porous carbon structure PCS may be in a range of about 1800 m²/g to about 2200 m²/g. For example, the BET specific surface area of the porous carbon structure PCS may be determined using the BET (Brunauer-Emmett-Teller) method.

The number of layers of graphene ESG in the porous carbon structure PCS may be in a range of about 1 to about 3. For example, the number of layers of graphene ESG in the porous carbon structure PCS may be in a range of about 1 to about 2, or about 1 to about 1.5. Single-layer (monolayer) graphene may have a structure in which carbon atoms are arranged to form a two-dimensional plane. The number of layers of graphene ESG may refer to the number of layers composed of or including carbon atoms on the two-dimensional plane constituting the graphene. The content of single-layer graphene contained in the porous carbon structure PCS may be in a range of about 60 wt % to about 100 wt %, or about 80 wt % to about 100 wt %.

For example, the porous carbon structure PCS may be manufactured by a manufacturing method including coating a carbon layer on a metal template to prepare a carbon-coated metal template, and removing the metal template. For example, the metal template may be or include an alumina particle.

For example, the number of layers of graphene ESG in the porous carbon structure PCS may be determined by the following method: carbon layers may be coated on about 7 nm alumina particles, then a weight of carbon may be calculated using thermogravimetric analysis (TGA), a surface area of the alumina particles may be calculated, and thereby a weight of the carbon layer per unit area may be determined. The number of layers may be calculated by dividing the weight of the carbon layer per unit area of the porous carbon structure PCS by the weight of the carbon layer per unit area of single-layer graphene (7.61×10⁻⁴ g/m²).

When the porous carbon structure PCS has the above-described structure, the porous carbon structure PCS may absorb expansion of the silicon-carbon composite SCS that may occur during charging and discharging. Thereby, the expansion rate of the negative electrode 20 during charging and discharging may be reduced, and a rechargeable lithium battery with a long lifespan may be provided.

Referring again to FIG. 7, the silicon-carbon composite SCS may include a crystalline carbon matrix CSP and silicon SNP dispersed within the crystalline carbon matrix CSP.

The silicon-carbon composite SCS according to examples of the present disclosure may be prepared by a manufacturing method including: preparing a mixture by mixing a carbon precursor and a metal catalyst, heat-treating the mixture to prepare a heat-treatment product, removing the metal catalyst from the heat-treatment product to prepare a crystalline carbon matrix CSP having a porous structure, and loading silicon SNP in the crystalline carbon matrix CSP.

An average particle diameter of the silicon-carbon composite SCS may be in a range of about 7 m to about 20 m. For example, in the present disclosure, the average particle diameter may be measured with a particle size analyzer or an electron microscope.

The silicon-carbon composite SCS may have a porous structure. The BET specific surface area of the silicon-carbon composite SCS may be in a range of about 8 m²/g or less, in a range of about 0.5 m²/g to about 8 m²/g, or about 1 m²/g to about 5 m²/g. In one example embodiment, the BET specific surface area may be the specific surface area obtained from adsorption isotherms by the BET (Brunauer, Emmett, Teller) method. In the measurement of adsorption isotherms, nitrogen gas may be used as the adsorption gas.

The degree of graphitization of the crystalline carbon matrix CSP may be in a range of about 95% or more, about 95% to about 99%, or about 97% to about 99%. As used herein, “degree of graphitization” refers to the proportion of layered structure contained in graphite. A high degree of graphitization means that the graphite contains a large amount of layered structure. For example, the degree of graphitization may be obtained by X-ray diffraction measurement. For example, using an X-ray diffraction analyzer (e.g., Bruker D8 Discover), after measuring d₀₀₂ in accordance with JIS K 0131-1996 or JB/T 4220-2011 standards, the degree of graphitization may be calculated as (0.344−d₀₀₂)/(0.344−0.3354)×100%, where d₀₀₂ is the interlayer spacing of the graphite crystal structure expressed in nanometers (nm). X-ray diffraction analysis may be performed using CuKα radiation as the target radiation, with wavelength λ=1.5418±0.02 Å, scan 2θ=20° to 80°, and scan rate of 1°/min to 5°/min. When the degree of graphitization of the crystalline carbon matrix CSP satisfies the above-described range, the negative electrode 20 with achieving high capacity and high density, and having high energy density may be manufactured.

The crystalline carbon matrix CSP may have a porous structure. The crystalline carbon matrix CSP may include pores, and the pores may constitute a buffer to absorb volume expansion. Accordingly, the crystalline carbon matrix CSP may absorb the volume expansion of silicon SNP that may occur during charging and discharging, thereby reducing or preventing the overall volume increase of the silicon-carbon composite SCS. As a result, the silicon-carbon composite SCS may maintain the structure thereof even during charging and discharging, and may improve the lifespan characteristics thereof.

The BET specific surface area of the crystalline carbon matrix CSP may be in a range of about 8 m²/g or less, about 0.5 m²/g to about 8 m²/g, or about 1 m²/g to about 6 m²/g. The porosity of the crystalline carbon matrix CSP may be in a range of about 1% to about 50%. For example, the porosity of the crystalline carbon matrix CSP may be in a range of about 1% to about 30%, or about 1% to about 20%. When the BET specific surface area and porosity of the crystalline carbon matrix CSP satisfy the above-described ranges, the crystalline carbon matrix CSP may effectively absorb the volume expansion of the silicon SNP, and the lifespan characteristics may be further improved.

For example, the porosity may be measured by mercury intrusion porosimetry. Alternatively, the porosity may be measured by the Barrett-Joyner-Halenda (BJH) method through N₂ adsorption-desorption isotherms. For example, the crystalline carbon matrix CSP may be heated to about 523K (Kelvin, absolute temperature) at a rate of about 10K/min, then pretreated by maintaining at this temperature and a pressure of about 100 mmHg or less for a duration in a range of about 2 to about 10 hours, followed by nitrogen adsorption at about 32 points from relative pressure in a range of about 0.01 torr to about 0.955 torr in liquid nitrogen adjusted to a relative pressure (P/Po) of about 0.01 torr or less, and then nitrogen desorption at about 24 points up to a relative pressure of about 0.14 torr. The porosity may be determined from the N₂ content measured by the above method relative to the volume of the crystalline carbon matrix (CSP).

For example, the crystalline carbon may be synthetic graphite, which may be non-shaped (amorphous), sheet-shaped (plate-like), flake-shaped, sphere-shaped (spherical), or fiber-shaped (fibrous) synthetic graphite.

Silicon SNP may be dispersed in the crystalline carbon matrix CSP. Silicon SNP may be dispersed inside the crystalline carbon matrix CSP. Thus, since silicon SNP may not be exposed to the outside, side reactions caused by contact between silicon SNP and the electrolyte may be reduced or suppressed. In addition, since the crystalline carbon matrix CSP may reduce or suppress volume expansion of silicon SNP during charging and discharging, the high-capacity characteristics of silicon SNP may be effectively utilized.

Silicon SNP may be nano-sized silicon, for example, silicon nanoparticles. The average diameter of silicon SNP may be in a range of about 80 nm or less. For example, the average diameter of silicon SNP may be in a range of about 1 nm to about 50 nm, about 1 nm to about 40 nm, about 1 nm to about 30 nm, about 1 nm to about 20 nm, or about 2 nm to about 15 nm. When the average diameter of silicon SNP satisfies the above-described range, volume expansion during charging and discharging may be reduced, and advantages favorable to lifespan characteristics may be obtained.

The content of silicon SNP may be in a range of about 1 wt % to about 55 wt % based on 100 wt % of the silicon-carbon composite SCS. For example, the content of silicon SNP may be in a range of about 5 wt % to about 55 wt %, about 10 wt % to about 55 wt %, or about 27 wt % to about 55 wt % based on 100 wt % of the silicon-carbon composite SCS. When the content of silicon SNP satisfies the above-described range, high capacity may be exhibited.

For example, silicon SNP may be pure silicon. For example, trace amounts of silicon oxide formed by natural oxidation of silicon may be present. When silicon oxide is present in trace amounts, initial efficiency may be high, thereby enabling implementation of a rechargeable lithium battery having higher efficiency. Furthermore, irreversible capacity may be very low and side reactions may be further reduced, thereby further improving lifespan characteristic of the rechargeable lithium battery.

The silicon-carbon composite SCS may support silicon SNP within a crystalline carbon matrix CSP having high crystallinity, thereby reducing side reactions with the electrolyte and achieving the advantages of both the high capacity of graphite and the high capacity of silicon SNP.

Referring again to FIG. 7, the second negative electrode active material layer AML23 may include graphite GPH. The graphite GPH may include at least one of natural graphite or artificial graphite. The graphite GPH may have a desired or improved capacity. The graphite GPH may have relatively high ductility.

In the particle size distribution, the D10 of graphite GPH may be in a range of about 3 m to about 15 m, or about 5 m to about 10 m. In the particle size distribution, the average particle diameter (D50) of graphite GPH may be in a range of about 5 m to about 20 m, or about m to about 20 m. For example, D10 and D50 may refer to the particle diameters corresponding to 10 vol % and 50 vol % of the cumulative volume, respectively, based on a particle size distribution obtained by randomly selecting and measuring the particle diameters of approximately 30 graphite GPH particles from, e.g., an electron microscope image of graphite GPH.

Graphite GPH may have a relatively small BET specific surface area. The BET specific surface area of graphite GPH may be in a range of about 0.5 m²/g to about 2 m²/g, or about 0.5 m²/g to about 1.5 m²/g.

In one example, the graphite GPH may further include graphitizable carbon (soft carbon) surrounding the graphite.

By including graphite GPH in the second negative electrode active material layer AML23, the second negative electrode active material layer AML23 may absorb the expansion of the first negative electrode active material layer AML21 that may occur during charging and discharging, and may reduce or prevent excessive increase in the volume of the negative electrode 20. Thereby, the expansion rate of the negative electrode 20 during charging and discharging may be reduced, and a rechargeable lithium battery with a long lifespan may be provided.

The negative electrode 20 according to the present disclosure, and the rechargeable lithium battery 100 including the negative electrode 20, may have the following characteristics.

The negative electrode 20 according to the present disclosure includes a first negative electrode active material layer AML21 and a second negative electrode active material layer AML23, thereby reducing or preventing volume expansion of the first negative electrode active material layer AML21 during charging and discharging. Furthermore, the negative electrode 20 according to the present disclosure includes the porous carbon structure PCS and the silicon-carbon composite SCS in the first negative electrode active material layer AML21, thereby more effectively reducing the volume expansion that may occur during charging and discharging. Thereby, a rechargeable lithium battery 100 having a desired or improved capacity retention rate may be provided. For example, the expansion rate of the negative electrode 20 may be about 27% or less, and the capacity retention rate of the rechargeable lithium battery may be about 92% or more.

In the following example embodiments, detailed descriptions of technical features that overlap with those described above with reference to FIG. 1 to FIG. 8 are omitted, and differences are described in detail.

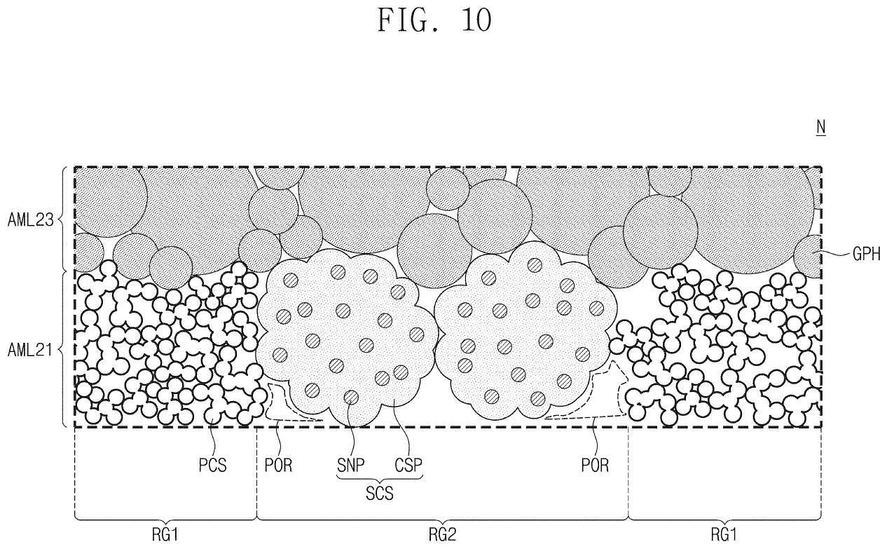

Referring to FIG. 9 and FIG. 10, the negative electrode 20 according to another example of the present disclosure may include a current collector COL2, a first negative electrode active material layer AML21 on the current collector COL2, and a second negative electrode active material layer AML23 on the first negative electrode active material layer AML21. The first negative electrode active material layer AML21 may include a first region RG1 and a second region RG2 that are disposed side by side in a horizontal direction. The first region RG1 may include the porous carbon structure PCS, and the second region RG2 may include the silicon-carbon composite SCS. The first negative electrode active material layer AML21 of the negative electrode 20 may include the porous carbon structure PCS and the silicon-carbon composite SCS such that the porous carbon structure PCS and the silicon-carbon composite SCS do not overlap with each other.

The first region RG1 may include a plurality of first regions. The plurality of first regions may be spaced apart from each other. The second region RG2 may include a plurality of second regions. The plurality of second regions may be spaced apart from each other. The plurality of first regions and the plurality of second regions may be alternately disposed side by side in a horizontal direction.

For example, a ratio of the width WD1 of the first region RG1 to the width WD2 of the second region RG2 may be in a range of about 1:1 to about 1:7. For example, the ratio of the width WD1 of the first region RG1 to the width WD2 of the second region RG2 may be in a range of about 1:1 to about 1:5, or about 1:1 to about 1:3. When the ratio of the width WD1 of the first region RG1 to the width WD2 of the second region RG2 satisfies the above-described range, the expansion of the silicon-carbon composite SCS within the second region RG2 that may occur during charging and discharging may be absorbed by the porous carbon structure PCS within the first region RG1. Thereby, the expansion rate of the negative electrode 20 during charging and discharging may be reduced, and a rechargeable lithium battery with a long lifespan may be provided.

For example, the first negative electrode active material layer AML21 of the negative electrode 20 according to the present disclosure may be formed by applying a first slurry containing the porous carbon structure PCS on a mesh film to form a plurality of first regions RG1, and then applying a second slurry containing the silicon-carbon composite SCS between the plurality of first regions RG1 to form a second region RG2.

For example, the negative electrode 20 according to the present disclosure may further include pores POR between the first region RG1 and the second region RG2. The pores POR may be formed between the porous carbon structure PCS and the silicon-carbon composite SCS. For example, the pores POR may be formed during the process of forming the second region RG2 by applying the second slurry between the plurality of first regions RG1.

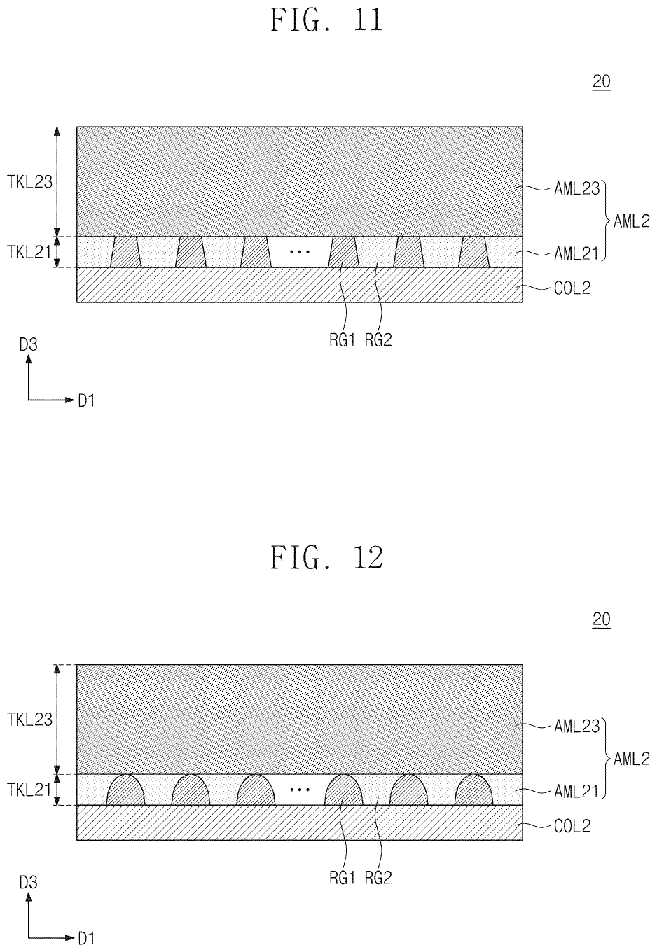

Referring to FIG. 11 and FIG. 12, the shapes of the first region RG1 and the second region RG2 of the negative electrode 20 according to another example of the present disclosure may vary.

Hereinafter, the present disclosure is described in more detail through examples. However, these examples are intended to illustrate the present disclosure by way of example, and the scope of the present disclosure is not limited to these examples.

### Example 1

A porous carbon structure containing graphene was prepared. The graphene of the porous carbon structure had an embossed structure. The average pore size of the porous carbon structure measured using BET was 8.7 nm, and the BET specific surface area was 1940 m²/g. The number of layers of graphene constituting the porous carbon structure, determined using a thermogravimetric analyzer (TGA), was 1.1.

A silicon-carbon composite was prepared by the following method. Lignin and Fe (average size (D50): 100 nm) were mixed at a weight ratio of 80:20 to prepare a mixture. The mixture was heat-treated at 1500° C. under N₂ atmosphere to prepare a heat treatment product including Fe and synthetic graphite. The heat treatment product was immersed in hydrochloric acid to prepare a porous synthetic graphite matrix from which the Fe was removed. The average size of pores in the porous graphite matrix was 80 nm, and the porosity was 16%. Furthermore, for the porous graphite matrix, the BET specific surface area obtained from the adsorption isotherm by the BET (Brunauer, Emmett, Teller) method was 6 m²/g. Using an X-ray diffraction analyzer (Bruker D8 Discover), the value of d₀₀₂ was measured according to JIS K 0131-1996, and the degree of graphitization calculated as (0.344−d₀₀₂)/(0.344-0.3354)×100% was 95%. Silicon was loaded on the prepared porous synthetic graphite matrix using chemical vapor deposition (CVD). Through this process, a silicon-carbon composite in which silicon was dispersed inside the porous synthetic graphite matrix was prepared. The average particle size (D50) of the silicon-carbon composite was 10 μm.

A first slurry was prepared by mixing 96.5 wt % of silicon-carbon composite, 1 wt % of porous carbon structure, 1 wt % of carboxymethyl cellulose, and 1.5 wt % of styrene butadiene rubber in an aqueous solvent.

A second slurry was prepared by mixing 97.5 wt % of synthetic graphite (GT from Zichen, D10=8 μm, D50=17 μm, BET specific surface area=1.2 m²/g), 1 wt % of carboxymethyl cellulose, and 1.5 wt % of styrene butadiene rubber in an aqueous solvent.

The first slurry was applied onto a negative electrode current collector (Cu foil, thickness 10 μm), then the second slurry was applied thereon, followed by drying and rolling to manufacture a negative electrode.

The manufactured negative electrode included a first negative electrode active material layer and a second negative electrode active material layer, wherein the first negative electrode active material layer included the porous carbon structure and the silicon-carbon composite, and the second negative electrode active material layer included graphite. The thickness of the first negative electrode active material layer was 10 μm, and the thickness of the second negative electrode active material layer was 100 μm.

### Example 2

A negative electrode was manufactured in the same manner as Example 1, except that the first negative electrode active material layer was formed by the following method.

A third slurry was prepared by mixing 97.5 wt % of the porous carbon structure, 1 wt % of carboxymethyl cellulose, and 1.5 wt % of styrene butadiene rubber in an aqueous solvent. A fourth slurry was prepared by mixing 97.5 wt % of the silicon-carbon composite, 1 wt % of carboxymethyl cellulose, and 1.5 wt % of styrene butadiene rubber in an aqueous solvent. A mesh film (line width 20 μm, height 10 μm, line spacing 20 μm) was attached to a negative electrode current collector (Cu foil, thickness 10 μm), and the third slurry was applied and dried to form a plurality of first regions. The mesh film was transferred and attached to the plurality of first regions, and then the fourth slurry was applied and dried to form a plurality of second regions. Thereafter, the mesh film was removed. Thus, a first negative electrode active material layer was formed in which the plurality of first regions and the plurality of second regions were alternately disposed side by side in a horizontal direction.

The manufactured negative electrode included a first negative electrode active material layer and a second negative electrode active material layer, wherein the first regions and the second regions of the first negative electrode active material layer contained the porous carbon structure and the silicon-carbon composite, respectively, and the second negative electrode active material layer contained graphite. The thickness of the first negative electrode active material layer was 10 μm, and the thickness of the second negative electrode active material layer was 100 μm. The width ratio of the first regions and second regions was 1:1.

### Comparative Example

A fifth slurry was prepared by mixing 96.5 wt % of silicon-carbon composite, 1 wt % of synthetic graphite (GT from Zichen), 1 wt % of carboxymethyl cellulose, and 1.5 wt % of styrene butadiene rubber in an aqueous solvent. The fifth slurry was applied and dried on a negative electrode current collector (Cu foil, thickness 10 μm) to form a negative electrode active material layer. The thickness of the negative electrode active material layer was 110 μm.

### Manufacture of Rechargeable Lithium Battery

LiCoO₂ 96 wt %, polyvinylidene fluoride (PVdF) 2 wt % and carbon black 2 wt % were mixed in N-methylpyrrolidone to prepare a slurry, which was applied to Al foil, dried and rolled to manufacture a positive electrode.

A rechargeable lithium battery was fabricated using the negative electrode and the positive electrode, a polyethylene separator, and an electrolyte. As the electrolyte, 1.5M LiPF₆ was dissolved in an organic solvent including ethylene carbonate (EC), diethyl carbonate (DEC) and dimethyl carbonate (DMC) mixed at a volume ratio of 2:1:7, and 3 parts by weight of fluoroethylene carbonate (FEC) was added per 100 parts by weight of the organic solvent.

### Experimental Example: Evaluation of the Expansion Rate of Negative Electrode and Lifespan of Rechargeable Lithium Battery

The expansion rate of the negative electrode and the lifespan of the rechargeable lithium battery were evaluated using rechargeable lithium batteries including the negative electrodes according to Examples 1, 2, and Comparative Example 1.

The expansion rate of the negative electrode was calculated as the ratio of the difference between the initial thickness of the negative electrode and the thickness of the negative electrode after charging the rechargeable lithium battery to 4.5V under constant current (0.33C) conditions, compared to the initial thickness of the negative electrode ((thickness after charging −initial thickness)/(initial thickness)×100%).

The lifespan (capacity retention rate) was evaluated by charging the rechargeable lithium battery to 4.5V under constant current (0.33C) conditions, resting for 10 minutes, then discharging to 2.5 V under constant current (0.5C) conditions to perform the initial charge and discharge, followed by repeating 100 cycles under the same charge-discharge conditions. The lifespan (capacity retention rate) was determined as the ratio of the discharge capacity after 100 cycles to the initial discharge capacity.

The results are shown in Table 1 below.

TABLE 1

| | Expansion rate of negative | Lifespan |
|---|---|---|
| Classification | electrode (%) | (%) |
| Example 1 | 26 | 93 |
| Example 2 | 24 | 93 |
| Comparative Example | 29 | 91 |

Referring to Table 1, the negative electrodes according to Examples 1 and 2 had lower expansion rates than the negative electrode according to the comparative example. The rechargeable lithium batteries including Examples 1 and 2 had longer lifespan than the rechargeable lithium battery including the comparative example. Thus, it can be confirmed that the negative electrodes according to Examples 1 and 2, having the first negative electrode active material layer and the second negative electrode active material layer and including the porous carbon structure, can provide rechargeable lithium batteries with low expansion rates and long lifespan.

In addition, the negative electrode according to Example 2 had a lower expansion rate than the negative electrode according to Example 1. It can thus be confirmed that the expansion rate of the negative electrode according to the present disclosure can be further reduced by substantially uniformly cross-coating the silicon-carbon composite and the porous carbon structure without overlapping each other.

The negative electrode according to one example embodiment of the present disclosure may have a low expansion rate during charging and discharging.

The rechargeable lithium battery according to one example embodiment of the present disclosure may have desired or improved lifespan characteristics.

While the present disclosure has been described with reference to example embodiments, it should be understood that these example embodiments are provided for illustrative purposes only and do not limit the scope of the present disclosure. Various modifications and equivalent arrangements may be made without departing from the spirit and scope of the appended claims. Accordingly, the described example embodiments should be regarded as examples rather than limitations of the present disclosure.

What is claimed is:

1. A negative electrode, comprising:
a negative electrode current collector;
a first negative electrode active material layer on the negative electrode current collector; and
a second negative electrode active material layer on the first negative electrode active material layer,
wherein the first negative electrode active material layer comprises a porous carbon structure and a silicon-carbon composite,
wherein the porous carbon structure comprises graphene, and
wherein the second negative electrode active material layer comprises graphite.

2. The negative electrode of claim 1, wherein:
the graphene of the porous carbon structure has an embossed structure, and
the porous carbon structure comprises mesopores.

3. The negative electrode of claim 1, wherein:
the number of layers of the graphene in the porous carbon structure is in a range of about 1 to about 3, and
a BET specific surface area of the porous carbon structure is in a range of about 1000 m²/g to about 2200 m²/g.

4. The negative electrode of claim 1, wherein an average particle diameter of the silicon-carbon composite is in a range of about 7 m to about 20 m.

5. The negative electrode of claim 1, wherein, in the first negative electrode active material layer, the porous carbon structure and the silicon-carbon composite have a weight ratio in a range of about 1:90 to about 1:99.

6. The negative electrode of claim 1, wherein an average particle diameter of the graphite is in a range of about 5 m to about 20 m.

7. The negative electrode of claim 1, wherein a BET specific surface area of the graphite is in a range of about 0.5 m²/g to about 2 m²/g.

8. The negative electrode of claim 1, wherein a thickness ratio of the first negative electrode active material layer to the second negative electrode active material layer is in a range of about 1:5 to about 1:15.

9. A negative electrode, comprising:
a negative electrode current collector;
a first negative electrode active material layer comprising a first region and a second region; and
a second negative electrode active material layer on the first negative electrode active material layer,
wherein the first region and the second region are disposed side by side in a horizontal direction,
wherein the first region comprises a porous carbon structure,
wherein the second region comprises a silicon-carbon composite, and
wherein the second negative electrode active material layer comprises graphite.

10. The negative electrode of claim 9, wherein the first region comprises a plurality of first regions,
wherein the second region comprises a plurality of second regions, and
wherein the plurality of first regions and the plurality of second regions are alternately disposed side by side in a horizontal direction.

11. The negative electrode of claim 9, wherein, in the first negative electrode active material layer, a ratio of a width of the first region to a width of the second region is in a range of about 1:1 to about 1:7.

12. The negative electrode of claim 9, wherein:
the porous carbon structure comprises graphene having an embossed structure, and
the porous carbon structure further comprises mesopores.

13. The negative electrode of claim 9, wherein:
the porous carbon structure comprises graphene,
the number of layers of the graphene in the porous carbon structure is in a range of about 1 to about 3, and
a BET specific surface area of the porous carbon structure is in a range of about 1000 m²/g to about 2200 m²/g.

14. The negative electrode of claim 9, wherein an average particle diameter of the silicon-carbon composite is in a range of about 7 m to about 20 m.

15. The negative electrode of claim 9, wherein an average particle size of the graphite is in a range of about 5 m to about 20 m.

16. The negative electrode of claim 9, wherein a BET specific surface area of the graphite is in a range of about 0.5 m²/g to about 2 m²/g.

17. The negative electrode of claim 9, wherein a thickness ratio of the first negative electrode active material layer to the second negative electrode active material layer is in a range of about 1:5 to about 1:15.

18. A rechargeable lithium battery comprising the negative electrode of claim 1.

19. The rechargeable lithium battery of claim 18, wherein an expansion rate of the negative electrode is about 27% or less.

20. The rechargeable lithium battery of claim 18, wherein a capacity retention rate of the rechargeable lithium battery is about 92% or more.
